(19) United States
(12) Patent Application Publication
(10) Pub. No.: US 2011/0259731 A1
(43) Pub. Date: Oct. 27, 2011

(54) METHOD AND APPARATUS FOR DISSOCIATING HYDROGEN AND OXYGEN FROM WATER

(76) Inventor: James Henley CORNWELL, Ridgecrest, CA (US)

(21) Appl. No.: 13/173,866

(22) Filed: Jun. 30, 2011

Related U.S. Application Data
(63) Continuation of application No. PCT/US2009/006736, filed on Dec. 30, 2009.
(60) Provisional application No. 61/142,312, filed on Jan. 2, 2009.

(51) Int. Cl. B01J 19/08; C01B 13/02; C01B 3/04

(52) U.S. Cl. 204/164; 422/186.04

(57) ABSTRACT

Water is dissociated into hydrogen and oxygen preferably using an adjacent plasma at or near atmosphere pressure and ambient temperature and generated preferably by a caduceus coil driving a frequency that creates a plasma shear and/or induces resonance in the water molecules.

### CROSS REFERENCE TO RELATED APPLICATION

This application is a continuation of International patent application No. PCT/US2009/006736, filed Dec. 30, 2009, which claims priority to Provisional patent application No. 61/142,312, filed Jan. 2, 2009, the contents of both being hereby incorporated by reference in their entirety.

### BACKGROUND OF THE INVENTION

Water (H20) is one of the most stable and abundant molecules on earth. The two constituent parts (hydrogen and oxygen) are of great economic value when isolated as gases. Hydrogen in particular has been the focus as fuel for future generations of automobiles and the like. An inherent problem, however, is the relative difficulty in dissociating hydrogen atoms from oxygen atoms in an economic and scalable fashion.

Electrolysis is a common mechanism for separating hydrogen and oxygen from water. Electolysis is the passage of an electric current through an electrolyte with subsequent migration of positively and negatively charged ions to the negative and positive electrodes. Electrolysis in water may result in the decomposition of the water (H20) into oxygen (02) and hydrogen gas (H2) due to an electric current being passed through the water. For instance, the water molecules may be broken into hydrogen and oxygen by placing leads from positive and negative battery terminals in the water. In such instance, hydrogen will appear at the cathode, and oxygen will appear at the anode. The generated amount of hydrogen is twice the amount of oxygen, and both are proportional to the total electrical charge that was sent through the water. The dissociated hydrogen is of course highly volatile; in fact it can be explosive.

However, the degree of electrical energy needed to create this dissociation of water into hydrogen and oxygen through electrolysis is high, and the process is therefore not particularly economical.

Thermolysis is another common mechanism for separating hydrogen and oxygen from water. Thermolysis is the dissociation or decomposition of chemical compounds by heat. Thermolysis of water, like electrolysis in water, results in the generation of hydrogen and oxygen. Thermolysis is also commonly used to crack hydrocarbons. Like electrolysis, the degree of thermal energy needed to create this dissociation of water into hydrogen and oxygen is high, and the process is therefore not particularly economical.

Recently, John Kanzius caused salt water to break into its constituent parts by impinging radio frequency waves at 13.56 MHz directly on salt water in a container between antennas. So long as the water is between the antennas and the radio frequency beam is impinging on the salt water, the effluent coming off the water actually burns at about 1800° C., if ignited. See, R. Roy et al., Observations of Polarized RF Radiation Catalysis of Dissociation of H2O-NaCl Solutions,” Materials Research Innovations, January 2008, Vol. 12, No. 1 As yet, it is not clear whether Mr. Kanzius has put this observation to use.

A purported method for dissociating water into hydrogen and oxygen is disclosed in U.S. Pat. No. 7,384,619. The disclosed method includes injecting water preferably in the form of steam or water vapor into a reactor containing a plasma. The method includes cracking water molecules into its constituent hydrogen and oxygen molecules, and subsequently separating the hydrogen from the oxygen.

### SUMMARY OF THE INVENTION

The presently disclosed method and apparatus for dissociating hydrogen and oxygen from water involves directing energy toward a contiguous plane of water molecules in a liquid state until the water molecules have weakened or broken bonding states between the oxygen and hydrogen atoms, and then separating the hydrogen from the oxygen using a molecular separator or filter that separates the hydrogen species from the oxygen species. The energy for dissociating the water molecules is in the form of a plasma located adjacent to the contiguous plane of water molecules in a liquid state.

### BRIEF DESCRIPTION OF THE DRAWINGS

FIG. 1 is a partially schematic view of an exemplary embodiment of the presently disclosed hydrogen/oxygen dissociated system.

FIG. 2 is a matrix of multiple hydrogen/oxygen dissociation systems.

FIG. 3 is a flowchart illustrating the process steps of the presently disclosed system.

### DETAILED DESCRIPTION

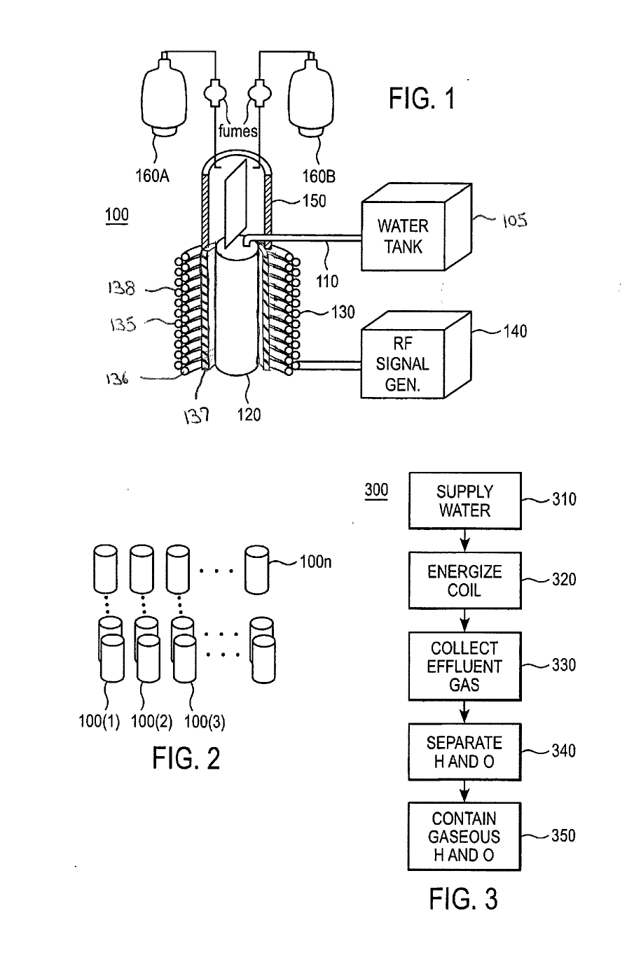

FIG. 1 illustrates an exemplary embodiment of the presently disclosed hydrogen and oxygen dissociation system, also referred to herein as a plasma induced dissociation unit 100. The plasma induced dissociation unit 100 includes a liquid input device 110 for conveying liquid state water from a reservoir or other supply 105 into a liquid containment vessel 120. The liquid input device 110 can be as simple as a pipe connected to a reservoir via a valve, but more preferably a flow control device that maintains a water level within a range in the liquid containment vessel 120. The liquid input device 110 can in the alternative be a mechanism permitting switching of one liquid containment vessel 120 that is depleted of water with another that has a supply of water.

The liquid containment vessel 120 is placed or is permanently located inside a plasma generator 130. The liquid containment vessel 120 can be cylindrically-shaped with one end sealed, or virtually any other suitable shaped vessel capable of containing liquid wherein liquid is input by the liquid input device 110, and allows for the removal of effluent gasses from the surface of the water in the containment vessel, via another opening or pipe. The liquid containment vessel 120 should be nonconductive and made of a dielectric, such as glass, particularly PYREX glass.

In still other embodiments, as further explained below, the liquid containment vessel 120 can be formed of a material that permits separation of atoms in gaseous state such that hydrogen, for instance, can be liberated through the walls of the liquid containment vessel 120, or alternatively, oxygen be liberated through the walls of the liquid containment vessel 120, or both hydrogen and oxygen can be liberated through the walls of the liquid containment vessel 120. In one form, the liquid containment vessel 120 is simply a cylindrically shaped PYREX glass vessel.

The plasma generator 130 can be any form of plasma generator that can impart energy to water preferably at a resonant frequency of the liquid water. For instance, the plasma generator may be low pressure or ambient pressure plasma generator. Suitable plasma generators can include capacitively coupled plasma (CCP) generators that generate plasma with high frequency RF electric fields, typically 13.56 MHz. Alternatively, inductively coupled plasma (ICP) plasma generators can be used, in which an electrode consists of a coil wrapped around the discharge volume which inductively excites the plasma. It is possible that other types of plasma generators can be used, such as wave heated plasma (e.g., helicon discharge, electron cyclotron resonance (ECR), and ion cyclotron resonance (ICR)) generated by an RF (or microwave) energy, but is heated by both electrostatic and electromagnetic means. The present system may also use an atmospheric pressure plasma generator (e.g., arc discharge, corona discharge, and dielectric barrier discharge (DBD)).

As illustrated, the plasma generator 130 induces inductively coupled discharges, and is in the form of a coil. The plasma is generated on an inner surface of the coil housing or coil structure in the form of toroidal or tube-shaped plasma. Most preferably the plasma generator is a caduceus coil 135 wherein an inner coil 136 is wound around a dielectric tube 137 in one direction and then an outer coil 138 (actually the same wire) is wound around the inner coil in the opposite direction such that the coil crosses itself repeatedly. While not wishing to be bound by theory, it appears that the caduceus coil 135, with its off set windings in opposite directions and driven at a high frequency (e.g. 4 MHz-8 GHz, and preferably at least one of 4 MHz, 9.15 MHz, 6.8 GHz or 7.12 GHz or other resonant frequency of water molecules rather than hydrogen atoms), the coil creates a plasma or axial shearing action with crossing induction lines, unlike prior art systems.

The plasma generator 130 in the exemplary embodiment shown in FIG. 1 induces a plasma on an inner surface of a dielectric tube 137 supporting the coils 136, 138 such that the plasma is in a toroidal or tubular shape surrounding the liquid containment vessel 120.

A power supply 140 supplies power to the plasma generator 130. In one embodiment, the power supply 140 is a high frequency (e.g., 4 MHz to 8 GHz) generator. The high frequency generator 140 generates a frequency at for example 13.6 MHz or 9.15 MHz or other resonant frequency of water molecules, to promote dissociation of the hydrogen and oxygen from the water. It should be noted that the number of turns in the coils, the dimension of the coils (both the size and cross section of the wire, and the diameter of the coils), the amount of current, the voltage levels and the frequency of the input signal can be optimized for a given application.

It should be further noted that the plasma can be at or near atmospheric pressure and ambient temperature, the water does not have to be vaporized or heated to a steam, and does not have to be salt water. Impurities in the water (whether NaCl or other molecules, chemicals, containments, or particulates) may or may not have an effect on the dissociation, but there presence or removal are not required for the system to work.

The individual water molecules in the water contained in the liquid containment vessel 120 are energized by the plasma particularly at the resonant frequency of water such that the molecular bonds between hydrogen and the oxygen are weakened and may be broken. While not wishing to be bound by theory, it appears that there may not be complete dissociation of the hydrogen and oxygen species, since the effluent gas burns rather than explodes as one might expect of hydrogen in an oxygen atmosphere. Whatever the theory, it appears that the water molecules are either dissociated into the component hydrogen and oxygen species, at least as to some population of the water molecules, or the individual atoms of the molecules are bound loosely or have a resonance that permits cracking of the molecule through molecular separation mechanisms or filters, and at least are bound if at all more loosely than water molecules that are not energized. It is also believed that water molecules in the energized state surface at the top of the liquid containment vessel 120 such that they may be extracted and subsequently separated into their constituent parts.

Molecules other than water such as hydrocarbons can also be dissociated using the plasma induced dissociation unit by adjusting the frequency of the signal being input to the coils to induce resonance in the molecules.

Through application of negative pressure or other suitable means such as a blower, the energized water molecules and/or hydrogen and oxygen are input to a molecular separator or sieve 150. The molecular separator or sieve 150 can be any suitable form of mechanism for separating dissimilar species such as ceramic membranes having a porosity that will allow passage of one constituent and not another to permit separation of the hydrogen from the oxygen, membranes such as ion transport membranes, zeolites, solid gels, dense ceramic materials, among others. One preferred mechanism is to use fluidized beads of A1203 in water towers that receive the effluent from the liquid containment vessel 120.

As shown in FIG. 2, commercialized embodiments could involve multiple plasma induced dissociation units 100A-100B . . . 100N in any suitable arrangements such as a matrix, and can be scaled to suit the commercial application.

It is envisioned that the molecular separator 150 is closely adjacent to the plasma generator so that the effluent from the liquid containment vessel does not revert to its normal energy state before separation. However, it is also envisioned that the energized effluent from the liquid containment vessel 120 can be conveyed through pipes or other suitable means to the molecular separator. Any suitable means, such as a fan, pump, thermal gradient, etc., can be optionally employed to draw or blow the effluent from the surface of the water in the containment vessel 120 into the molecular separator 150. As illustrated in FIG. 1, a pump is located at the entrance of each gas containment vessel 160A and 160B to both draw the effluent from the liquid containment vessel 120 through the molecular separator 150 and to compress the separated gases in the gas containment vessels 160A and 160B. The separated gases may also be placed in a liquid state, for storage and/or transportation.

Said differently, once the species of oxygen and hydrogen have been separated, the separated species are then held in the gas containment vessels 160A and 160B. By way of example, the hydrogen and/or oxygen can be pressurized into its liquid state for transport by way of conventional mechanisms for pressurizing gases into its liquid state.

As shown in FIG. 3, a method 300 of dissociating oxygen and hydrogen from water in a liquid state using a plasma induced dissociation unit 100 involves the steps of supplying water to a containment vessel 120 (step 310), supplying power by a power supply 140 to a plasma generator 130 to generate a plasma adjacent to the liquid containment vessel 120 and consequently directing energy toward a contiguous plane of water molecules in a liquid state (step 320), causing an effluent from the containment vessel 120 to enter a molecular separator 150 (step 330) and containing the oxygen and hydrogen species separated by the molecular separator 150 into gas containment vessels 160A and 160B (step 340).

The present invention has been described by way of exemplary embodiments to which it is not limited. Variations and modifications will occur to those skilled in the art without departing from the scope of the present invention.

1. A method of generating hydrogen and oxygen gas, comprising the steps of:
supplying water to a containment vessel;
energizing an electrical coil surrounding said containment vessel with a high frequency electrical signal;
directing a plasma shear energy toward a contiguous plane of water molecules in a liquid state causing an effluent from the containment vessel; and
separating oxygen and hydrogen gases from the effluent by use of a molecular separation device.

2. The method of claim 1, wherein said high frequency is selected to induce resonance in the water molecules.

3. The method of claim 1, further comprising the step of drawing effluent from said containment vessel into said separation device by means of negative pressure.

4. The method of claim 1, wherein the electric coil comprises crossing induction lines.

5. The method of claim 1, wherein the electrical coil is a caduceus coil comprising an inner coil wound around a dielectric material in one direction and another coil wound around the inner coil in the opposite direction such that the inner coil and the another coil crosses each other.

6. The method of claim 5, wherein the another coil is an outer coil.

7. The method of claim 5, wherein the inner coil and the another coil are formed from the same wire.

8. The method of claim 1, wherein the electric coil is wound around a dielectric material.

9. The method of claim 1, wherein the containment vessel is formed of a dielectric material.

10. The method of claim 1, wherein the liquid containment vessel is located inside a plasma generator.

11. The method of claim 1, wherein the electric coil is energized by a high frequency generator having a frequency range of between about 4 MHz to about 8 GHz.

12. The method of claim 1, wherein the molecular separation device is a gas separation device that includes at least one of Al₂0₃ beads, a porous membrane and a molecular sieve.

13. A device generating hydrogen and oxygen gas, comprising;
a containment vessel for holding water;
a plasma generator for directing a plasma shear energy toward water molecules in the containment vessel, the plasma generator comprising an electrical coil surrounding said containment vessel;
a power supply for supplying a high frequency electrical signal to said coil of said plasma generator; and
a molecular separation device for separating oxygen and hydrogen effluent gases liberated from water in the containment vessel.

14. The device of claim 13, wherein said power supply supplies a high frequency that induces resonance in the water molecules.

15. The device of claim 13, wherein said containment vessel is formed of a non-conductive material.

16. The device of claim 13, wherein said containment vessel is formed of a dielectric material.

17. The device of claim 13, wherein the electric coil surrounds a dielectric material.

18. The device of claim 13, wherein the plasma generator comprises crossing induction lines.

19. The device of claim 13, wherein said coil is a caduceus coil.

20. The device of claim 19, wherein the caduceus coil comprises an inner coil wound around a dielectric material in one direction and another coil wound around the inner coil in an opposite direction such that the inner coil and the another coil cross each other.

21. The device of claim 20, wherein the inner coil and the another coil are formed from the same wire.

22. The device of claim 13, wherein the power supply is a high frequency generator for supplying a high frequency signal to the coil of between about 4 MHz to about 8 GHz.

23. The device of claim 1, further comprising means for drawing effluent from said water in said containment vessel.

24. The device of claim 13, wherein said molecular separation device is a gas separation filter that includes at least one of Al₂0₃ beads, a porous membrane and a molecular sieve.

25. The device of claim 13, further comprising a liquid input device for supplying water to the liquid containment device.

26. A device for generating hydrogen gas comprising:
a containment device for water formed of non-conductive material;
a plasma generator comprising an electric coil surrounding a dielectric material that forms a cavity, the electric coil having an inner coil wound around the dielectric material in a first direction and another coil wound around the inner coil in the opposite direction such that the inner coil crosses the another coil;
a power supply for supplying a high frequency electric signal of between about 6 MHz to about 8 GHz to the coil of the plasma generator; and
a molecular separation device for separating hydrogen gases,
wherein the containment device is located within the cavity formed by the dielectric material to form a plasma between the dielectric material and the containment device.
